(19) United States
(12) Patent Application Publication
(10) Pub. No.: US 2022/0349491 A1
(43) Pub. Date: Nov. 3, 2022

(54) MODULATING PILOT VALVE ASSEMBLY

(71) Applicant: Baker Hughes Oilfield Operations LLC, Houston, TX (US)

(72) Inventor: Rajesh Krithivasan, St. Johns, FL (US)

(21) Appl. No.: 17/243,976

(22) Filed: Apr. 29, 2021

(51) Int. Cl. F16K 31/124; F16K 17/02

(52) U.S. Cl. CPC F16K 31/1245; F16K 17/02

(57) ABSTRACT

Systems, devices, and methods of modulating a pressure relief valve are provided. A modulating pilot valve assembly can receive an inlet pressure of an inlet of a pressure relief valve and can receive a dome area pressure of a dome area of the pressure relief valve. The modulating pilot valve assembly and the pressure relief valve can be configured to maintain a leak-tight seal until reaching a pilot valve pressure set point, at which the modulating pilot valve assembly instantly reduces the dome area pressure instantly, via a biasing mechanism of the modulating pilot valve assembly causing the pressure relief valve to initially open and thereafter to progressively reduce the dome area pressure in proportion to an increase in the inlet pressure and to cause the pressure relief valve to open in proportion to the increase in the inlet pressure.

### BACKGROUND

Pressure relief valves are mechanical devices which are commonly used on process piping or pressure vessels, such as in power generation, refining or oil and gas production environments, for overpressure protection. Pressure relief valves prevent the vessels and the pipelines connecting them from exceeding pressure thresholds, above which the vessels or pipelines may fail causing potentially catastrophic damage.

One type of pressure relief valve, a pilot operated pressure relief valve, can include a main valve that is connected to the piping or the vessel to provide overpressure protection and a pilot valve that controls the operation of the main valve. The pilot valves can be configured to sense the pressure within the pressure relief valve or the pressure within the pipeline or the vessel and can be preset to actuate the safety relief valve in response to the sensed pressure. Pilot valves are commonly configured as “pop” type pilot valves which open at a predetermined pressure and cause the pressure relief valve to open to its full open position or as “modulating” type pilot valves which open at a predetermined pressure cause the pressure relief valve to open progressively in response to the sensed pressure.

### SUMMARY

In general, apparatuses, systems, and methods for modulating a pressure relief valve are provided.

In one aspect, a modulating pilot valve assembly is provided. In one embodiment the modulating pilot valve assembly can include a first chamber coupled to a pilot valve on a pressure relief valve. The first chamber can be configured to receive an inlet pressure of an inlet of the pressure relief valve via a first conduit coupling the pilot valve to the inlet of the pressure relief valve. The pilot valve can also include a first biasing mechanism configured to adjust a pilot valve pressure set point. The modulating pilot valve assembly can also include a second chamber coupled to the pilot valve. The second chamber can be configured to receive a dome area pressure of the pressure relief valve via a second conduit coupling the pilot valve to the dome area of the pressure relief valve. The modulating pilot valve assembly can further include a modulator piston between the first chamber and the second chamber. The modulator piston can include a top surface to which the inlet pressure is applied within the second chamber and a bottom surface to which the dome area pressure is applied within the second chamber. An area of the bottom surface can be greater than an area of the top surface. The modulating pilot valve assembly and the pressure relief valve can be configured to maintain a leak-tight seal until reaching the pilot valve pressure set point, at which the modulating pilot valve assembly instantly reduces the dome area pressure via a second biasing mechanism of the modulating pilot value assembly, causing the pressure relief valve to initially open and thereafter, to progressively reduce the dome area pressure in proportion to an increase in the inlet pressure and to cause the pressure relief valve to open in proportion to the increase in the inlet pressure.

In another aspect, a method for modulating a pressure relief valve is provided. In one embodiment the method can include receiving, in a first chamber of a modulating pilot valve assembly coupled to a pilot valve, an inlet pressure of an inlet of a pressure relief valve. The inlet pressure can be received via a first conduit coupling the pilot valve to the inlet of the pressure relief valve. The pilot valve can include a first biasing mechanism configured to adjust a pilot valve pressure set point. The method can also include receiving, in a second chamber of the modulating pilot valve assembly coupled to the pilot valve, a dome area pressure of a dome area of the pressure relief valve. The dome area pressure can be received via a second conduit coupling the pilot valve to the dome area of the pressure relief valve. An area of the first chamber can be greater than an area of the second chamber. The method can further include applying, within the first chamber, the inlet pressure to a top surface of a modulator piston in the second chamber. The method can also include maintaining a leak-tight seal of the modulating pilot valve assembly and the pressure relief valve until the modulating pilot valve assembly reaches the pilot valve pressure set point and communicating the dome area pressure to the second chamber when the pilot valve pressure set point is reached. The method can also include applying, within the second chamber, the dome area pressure to a bottom surface of the modulator piston and instantly reducing the dome area pressure to a predetermined value to start opening the pressure relief valve. The method can also include reducing, by the modulating pilot valve assembly in a progressive manner, the dome area pressure to a predetermined value in proportion to an increase in the inlet pressure. The method can further include opening the pressure relief valve based on progressively reducing the dome area pressure to the predetermined value in proportion to the increase in the inlet pressure.

In another aspect, a pressure relief valve system is provided. In one embodiment, the pressure relief valve system can include a pressure relief valve that can be configured to modulate a flow of a fluid therethrough. The pressure relief valve can include an inlet area having an inlet pressure and a dome area having a dome area pressure. The pressure relief valve system can also include a pilot valve coupled to the pressure relief valve. The pilot valve can be configured to receive the inlet pressure and the dome area pressure. The pilot valve can include a first biasing mechanism configured to adjust a pilot valve pressure set point. The pressure relief valve system can also include a modulating pilot valve assembly coupled to the pilot valve. The modulating pilot valve assembly can include a first chamber coupled to the pilot valve. The first chamber can be configured to receive the inlet pressure via a first conduit coupling the pilot valve to the inlet of the pressure relief valve. The modulating pilot valve assembly can also include a second chamber, coupled to the pilot valve. The second chamber can be configured to receive the dome area pressure via a second conduit coupling the pilot valve to the dome area of the pressure relief valve. The modulating pilot valve assembly can further include a modulator piston between the first chamber and the second chamber. The modulator piston can include a top surface to which the inlet pressure is applied within the first chamber and a bottom surface to which the dome area pressure is applied within the second chamber. An area of the bottom surface can be greater than an area of the top surface. The modulating pilot valve assembly and the pressure relief valve are configured to maintain a leak-tight seal until reaching the pilot valve pressure set point, at which the modulating pilot valve assembly instantly reduces the dome area pressure, via a second biasing mechanism of the modulating pilot valve assembly, causing the pressure relief valve to initially open and thereafter to progressively reduce the dome area pressure in proportion to an increase in the inlet pressure and to cause the pressure relief valve to open in proportion to the increase in the inlet pressure.

### DESCRIPTION OF DRAWINGS

These and other features will be more readily understood from the following detailed description taken in conjunction with the accompanying drawings, in which:

FIG. 1 is a side view of one exemplary embodiment of a pressure relief valve system including a modulating pilot valve assembly;

FIG. 2 is a top view of the pressure relief valve system including the modulating pilot valve assembly of FIG. 1;

FIG. 3 is a cross-sectional side view of a pressure relief valve of the pressure relief valve system of FIG. 1;

FIG. 4 is a cross-sectional side view of the pilot valve and the modulating pilot valve assembly of FIG. 1;

FIG. 5 is an enlarged cross-sectional view of the modulating pilot valve assembly of FIG. 4;

FIG. 6 is a cross-sectional view of another exemplary embodiment of a pilot valve and the modulating pilot valve assembly;

FIG. 7 is a cross-sectional view of another embodiment of a pilot valve and a modulating pilot valve assembly; and

FIG. 8 is a flow chart showing an exemplary embodiment of a method for modulating a pressure relief valve using the modulating pilot valve assembly of FIGS. 1-7.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Pilot valves can control the opening of a pressure relief valve to which they are coupled and to modulate the opening of the pressure relief valve. Pilot valves can be configured to actuate and cause the pressure relief valve to open when the pilot valve reaches a pressure set point associated with an operating pressure of the pressure relief valve. Traditionally, pilot valves can be configured to “pop” open at the pressure set point and cause the pressure relief valve to actuate and open instantaneously to relieve its full rated capacity. “Pop”-type pilot valves can include drawbacks such as allowing excess leakage to be discharged from the pressure relief valve in response to the immediate opening of the pressure relief valve and increased material strain and fatigue in pressure relief valve components resulting from the repeated rapid actuation of the piston within the pressure relief valve. Traditional “pop”-type pilot valves can further cause the piston of the pressure relief valve to actuate at rapid rates due to the instant and immediate actuation of the pilot valve in response to frequently changing operating pressures within the pressure relief valve. These drawbacks can cause the pressure relief valve to leak prematurely with respect to the pressure set point and can further result in larger operating gaps and reduced valve tightness. These drawbacks present significant concerns to pressure relief valve operators due to the complexity and cost of maintaining “pop”-type pilot valves, as well as the reduction in operating efficiencies and increased media loss.

In embodiments presented herein, a modulating pilot valve assembly can control the operation of a pressure relief valve, for example the opening, the rate of opening and closing of the pressure relief valve. The operating fluid pressure can be provided to the pressure relief valve through the modulating pilot valve to a chamber (hereto referred as dome) in the pressure relief valve. This fluid pressure in this chamber (hereto referred as dome pressure) can acts on a piston providing a downward force biased against the inlet pressure of the pilot operated pressure relief valve keeping it closed during normal operation. When the inlet pressure reaches a preset opening pressure value (hereto referred as set pressure), the pilot valve, which is connected to the pressure relief valve, can actuate to reduce the dome pressure providing the downward force. This reduction can cause the biasing force to zero at the preset value to enable the upward motion of the piston, thus opening the pressure relief valve. After the opening, the inlet pressure increase can cause the dome pressure and the downward force to progressively reduce at the modulating pilot valve causing a movement of piston in the pressure relief valve proportional to the inlet pressure.

An improved modulating pilot valve assembly, as described herein, can provide continuous modulation of “pop”-type pilot valves, tighter operating gaps, reduced leakage, and result in more efficient operation and control of the safety relief to which the pilot valve is be coupled. The modulating pilot valve assembly can control the opening and closing of the pressure relief valve in proportion to changes in the inlet pressure of the pressure relief valve. In response to the inlet pressure of the pressure relief valve reaching the pilot valve pressure set point, the modulating pilot valve assembly can receive, via the pilot valve, the dome pressure from the dome area of the pressure relief valve. The modulating pilot valve assembly which stays leak tight till the set point, can then reduce the dome pressure to a predetermined value and continue to operate progressively reduce the dome area pressure in direct response and proportion to increases in the inlet pressure of the pressure relief valve. Once the dome area pressure drops to the predetermined value, the pressure relief valve actuates and begins to open. As the inlet pressure of the pressure relief valve increases, the dome area pressure is decreased until the inlet pressure reaches a threshold accumulation pressure of the pressure relief valve assembly. In response to the inlet pressure reaching the threshold accumulation pressure set point, the modulating pilot valve assembly further reduces the dome area pressure such that the pressure relief valve opens fully.

The systems, devices, and methods herein also produce a number of additional advantages and/or technical effects. The modulating pilot valve assembly described herein maintains the tightness of the pressure relief valve and reduces the incidence of pressure relief valve and pilot valve leakage until the pilot valve pressure set point is reached. This is achieved by the separating the actuation of the pilot valve assembly (first chamber) and the modulating pilot valve assembly (second chamber) wherein the modulating pilot valve assembly does not relieve any process fluid till the pilot valve set point is reached maintaining a leak-tight pilot valve and safety relief valve. Only after the set pressure does the modulating pilot valve assembly vent the dome area pressure providing continuous modulation of the pilot valve which results from the discharge of dome area pressure in proportion to increases in the inlet pressure of the pressure relief valve. As a result, the modulating pilot valve assembly allows pressure relief valve operators to maintain tighter operating gaps while and more efficient operating conditions of the pressure relief valve.

An additional advantage and/or technical effect of the systems, methods, and devices herein can include refitting or upgrading pressure relief valve systems are not configured with a modulating pilot valve assembly. The modulating pilot valve assemblies described herein can include a variety of mounting or coupling mechanisms so that pressure relief valve operators have multiple options when considering pilot valve assembly replacements or seek to add a modulating pilot valve assembly to existing pilot valves. For example, the modulating pilot valve assemblies described herein can be coupled to the pilot valve via fluidic conduits or tubing, or via a coupling mechanism such as a bracket. In some embodiments, the modulating pilot valve assembly can be integrated within the pilot valve assembly. In this way, operators can refit existing pressure relief valves, which may have been previously configured with non-modulating pilot valve assemblies, to modulating pilot valve assemblies by coupling or integrating the modulating pilot as desired for their particular application or usage requirements.

Embodiments of systems, devices, and corresponding methods of modulating a pilot valve configured to actuate a pressure relief valve using a modulating pilot valve assembly in an oil and gas production environment are discussed herein. However, embodiments of the disclosure can be employed for modulating other valve types which can be configured with a pilot valve in other types of environments without limit.

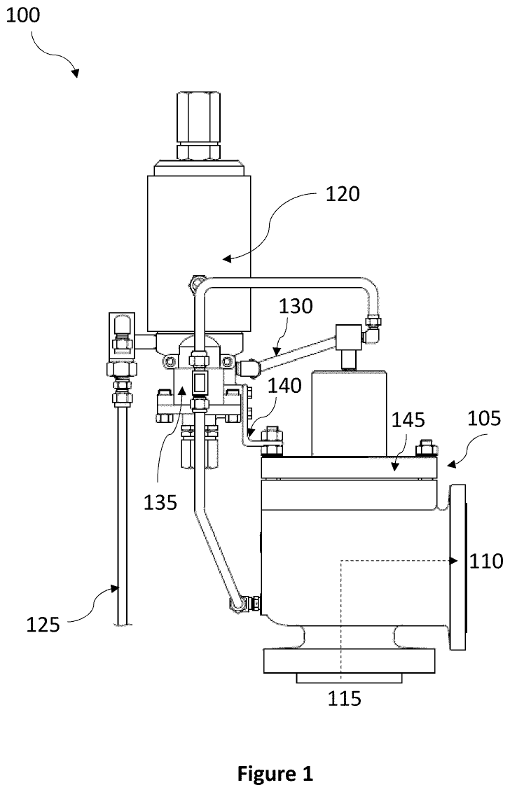

FIG. 1 is a side view of one exemplary embodiment of a pressure relief valve system 100 including a modulating pilot valve assembly. As shown in FIG. 1, the system 100 includes a pressure relief valve 105. The pressure relief valve 105 can be configured to control a flow of a fluid received via an inlet 115 and output via an outlet 110. The flow of fluid that is controlled via the pressure relief valve system 100 is shown as a dashed line connecting the inlet 115 and outlet 110. In some embodiments, the fluid can be a liquid, a gas, and/or a steam.

The pressure relief valve system 100 also includes a pilot valve 120. The pilot valve 120 can be coupled to the pressure relief valve 105 via one or more conduits configured to convey one or more pressures associated with the fluid flowing within the pressure relief valve 105 to the pilot valve 120. For example, the pilot valve 120 can control opening and closing the pressure relief valve 105 based on an inlet pressure of the pressure relief valve 105 that can be conveyed via inlet conduit 125 and a dome area pressure of the pressure relief valve 105 that can be conveyed via dome area conduit 130. In some embodiments, such as when the fluid is a liquid, a steam, or a gas, the inlet pressure can be between about 15 and 15000 pounds per square inch relative to atmospheric pressure.

As further shown in FIG. 1, the pressure relief valve system 100 can include a modulating pilot valve assembly 135. The modulating pilot valve assembly 135 can be coupled to the pilot valve 120 and to the pressure relief valve 105 such that the inlet pressure of the pressure relief valve and the dome area pressure of the pressure relief valve can be received within the modulating pilot valve assembly 135.

In the embodiment shown in FIG. 1, the modulating pilot valve assembly 135 can be attached to the pressure relief valve 105 via a mounting plate 140. The mounting plate 140 can attach to a portion of the pressure relief valve 105, such as an upper surface of a cover plate 145 of the pressure relief valve 105, and to a portion of the pilot valve 120. The mounting plate 140 can be configured to couple the portion of the pressure relief valve 105 and to the portion of the pilot valve 120 via a plurality of bolts, screws, or similar attachment mechanisms.

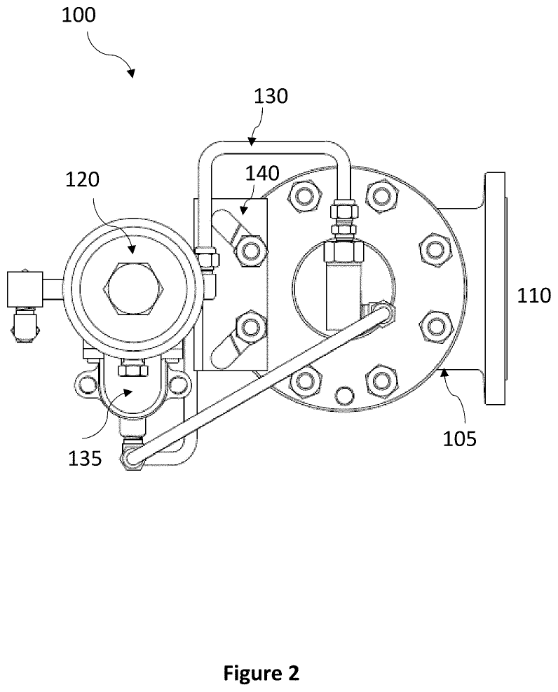

FIG. 2 is a top view of the pressure relief valve system 100 including the modulating pilot valve assembly 135 of FIG. 1. As shown in FIG. 2, the pressure relief valve 105 can be coupled to the pilot valve 120 via one or more conduits. For example, conduit 130 can be configured to transmit a dome area pressure from a dome area 310 of the pressure relief valve 105 to the modulating pilot valve assembly 135 via the pilot valve 120.

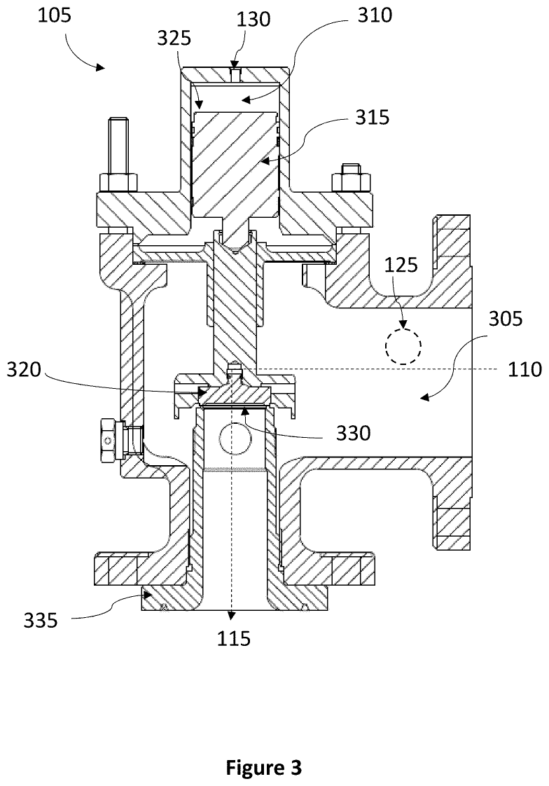

FIG. 3 is a cross-sectional side view of a pressure relief valve of the pressure relief valve system of FIG. 1. As shown in FIG. 3, the pressure relief valve 105 includes an inlet 110 through which a flow of a fluid is controlled as it passes to an outlet 115. The pressure relief valve includes an inlet area 305. The inlet area 305 can convey an inlet pressure to the pilot valve 120 and to the pilot modulation assembly 135 via conduit 125. The pressure relief valve also includes a dome area 310 which can convey a dome area pressure to the pilot valve 120 and to the pilot modulation assembly 135 via conduit 130. The modulator piston 315 can include a top surface 325 which is configured to have a larger surface area than the bottom surface 330 of the disc 320. The modulator piston 315 can be configured to use the dome area pressure acting on the top surface 325 to which is transferred to disc 320. When the pressure at the inlet 115 and the pressure at the dome area 310 are equal during the normal operation of the valve, the pressure acting on the larger area of the top surface 325 keeps the valve in the closed position against the pressure acting on the smaller area of the bottom surface 330 f (as shown in FIG. 3). As the disc 320 actuates upward from a closed position to an open position, the flow of fluid exerts pressure against a nozzle 335 to cause the flow of fluid to exit the outlet 115.

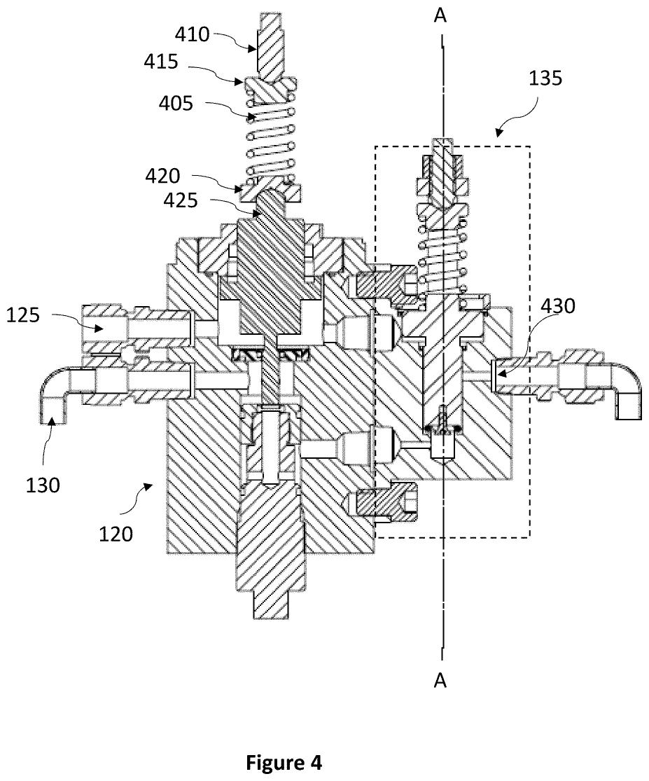

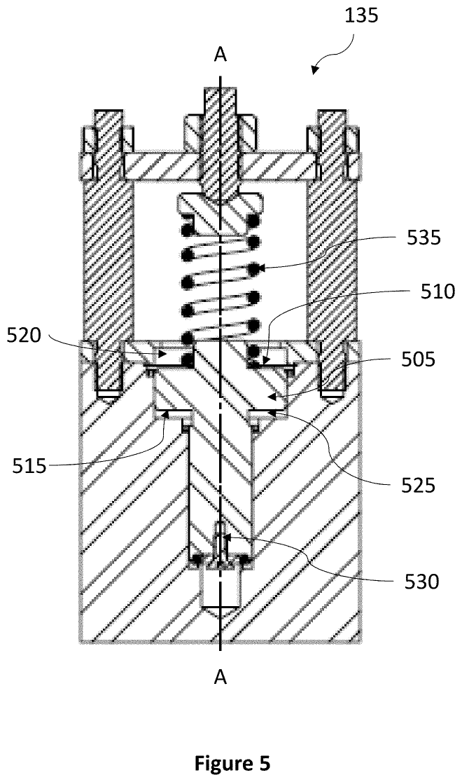

FIG. 4 is a cross-sectional side view of an embodiment of the pilot valve 120 and the modulating pilot valve assembly 135 of FIG. 1. In the embodiment shown in FIG. 4, the modulating pilot valve assembly 135 is configured as a modular component that can be attached to the pilot valve 120 to provide modulation of the pilot valve 120 thereby controlling the opening/closing of the pressure relief valve 105. For example, the modulating pilot valve assembly 135 can be configured to couple to the pilot valve 120 via a plurality of fittings, bolts, threaded connections, or the like. This configuration provides easier field conversion when transitioning from “pop”-type pilot valve operation to modular pilot valve operation. The modulating pilot valve assembly 135 shown in FIG. 4 within the dashed-line box will be described further in FIG. 5.

The pilot valve 120 and the modulating pilot valve assembly 135 can control the opening and closing of a pressure relief valve, such as the pressure relief valve 105 in FIGS. 1-2, in proportion to changes in the inlet system pressure conveyed via conduit 125. As shown in FIG. 4, the pilot valve 120 can include a spring 405 and an adjustment mechanism, such as a compression screw 410. In response to adjusting the compression screw 410, the spring 405 can exert a force against the top spring washer 415 and the bottom spring washer 420 to create a biasing force against the piston 425. In this way, the spring 405 and the compression screw 415 can form a biasing mechanism that can adjust a pressure set point of the pilot valve 120. In some embodiments, the biasing mechanism can be configured without a spring. For example, the biasing mechanism can include a washer, a seal configured to induce drag, or the like. The modulating pilot valve assembly 135 also includes a vent port 430. The vent port 430 can vent to the atmosphere or to a vent pipe of the pressure relief valve 105.

During operation, the pilot valve 120 conveys the inlet pressure of the pressure relief valve 105 received via conduit 125 to the dome area 310 of the pressure relief valve via conduit 130 shown in FIGS. 1 and 3 or other conduits coupling the pilot valve 120 to portions of the pressure relief valve 105. This equalizes the pressure on top of the disc 320 configured within the pressure relief valve 105 with the inlet pressure that is applied to the bottom of the disc 320. The disc 320 can be configured with differential areas for the top surface 325 and the bottom surface 330, such the area of the top surface 325 of the disc 320 is greater than the area of the bottom surface 330 of the disc 320. This differential area results in a net downward force which keeps the pressure relief valve 105 tightly closed to maintain a leak-tight seal. As the inlet pressure increases, the pilot valve piston 425 strokes and seals off the inlet pressure from the dome area pressure. The pilot valve 120 can simultaneously and instantaneously open a vent seal to relieve the dome area pressure to the modulating pilot valve assembly 135 to begin modulating the operation of the pressure relief valve 105.

FIG. 5 shows an enlarged cross-sectional view of the modulating pilot valve assembly 135 of FIG. 4. The cross-sectional view of the modulating pilot valve assembly 135 shown in FIG. 5 corresponds to the cross-section identified via the dashed line A-A in FIG. 4 and is provided in a perspective that is normal to the plane of the figure and rotated 90 degrees. The modulating pilot valve assembly 135 can be coupled to the pilot valve 120 and can receive an inlet pressure of the pressure relief valve 105 via a first conduit 125, as shown in FIG. 4 and a dome area pressure of the pressure relief valve 105 via a second conduit 130 as shown in FIG. 4. The modulating pilot valve assembly 135 includes a modulator piston 505 which is configured with a top surface 510 and a bottom surface 515. The area of the bottom surface 515 can be greater than the area of the top surface 510. The piston modulator 505 can be configured to separate a first chamber 520 and a second chamber 525. The first chamber 520 can be configured to receive the inlet pressure of the pressure relief valve 105 via conduit 125. The second chamber 525 can be configured to receive the dome area pressure of the pressure relief valve 105 via conduit 130. The area of the first chamber 520 can be greater than the area of the second chamber 525. In some embodiments, the modulating pilot valve assembly 135 can include additional chambers to receive the inlet pressure. In some embodiments, the modulating pilot valve assembly 135 can include additional chambers to receive the dome area pressure.

The modulating pilot valve assembly 135 also includes a lock screw 530 and a biasing mechanism 535. The lock screw 530 and the biasing mechanism 535 can be adjusted to configure the modulating pilot valve assembly 135 to instantly reduce the dome area pressure in response to proportional increases in the inlet pressure of the pressure relief valve 105 once the pilot valve 120 has reached a pilot valve pressure set point. In some embodiments, the biasing mechanism 535 can include a spring, as shown in FIG. 5. In some embodiments, the biasing mechanism 535 can include a hydraulic piston to provide a preset biasing force to cause the reduction in the dome area pressure.

During operation, as the pilot valve 120 has reached its pressure set point, the pilot valve 120 vents the dome area pressure via conduit 130 to the bottom surface 515 of the piston 505 configured within the modulating pilot valve assembly 135. The bottom surface 515 and the top surface 510 of the modulator piston 505 are configured with differential surface areas, such that an area of the top surface 510 is smaller than an area of the bottom surface 515. The top surface 510 is configured to receive the inlet pressure of the pressure relief valve conveyed via conduit 125. A net upward force is created based the dome area pressure being applied to the bottom surface 515. The net upward force results from equivocal inlet pressure and dome area pressure, as well as surface area differential of the top surface 510 and the bottom surface 515 of the modulator piston 505.

The modulating pilot valve assembly 135 relieves the dome area pressure to the atmosphere until the force from the inlet pressure applied to the top surface 510 of the modulator piston 505 is sufficient to initiate moving the modulator piston 505 into a closed position. A residual amount of dome area pressure remains in the dome area 310 of the pressure relief valve 105 which is controlled by the differential areas of the top surface 510 and the bottom surface 515 of the modulator piston 505. Since the dome area pressure has not been fully relieved to atmospheric pressure, the pressure relief valve 105 can partially open at the pilot valve pressure set point The modulator piston 505 remains closed until the disc 320 within the pressure relief valve 105 is forced into higher lift by increasing inlet pressures. As this occurs, the modulator piston 505 may further relieve the dome area pressure as necessary to maintain the required disc 320 lift within 10% overpressure. In this way, the modulating pilot valve assembly can be configured to maintain leak-tight seal of the pressure relief valve 105 between about 96% and 99% of the pilot valve pressure set point.

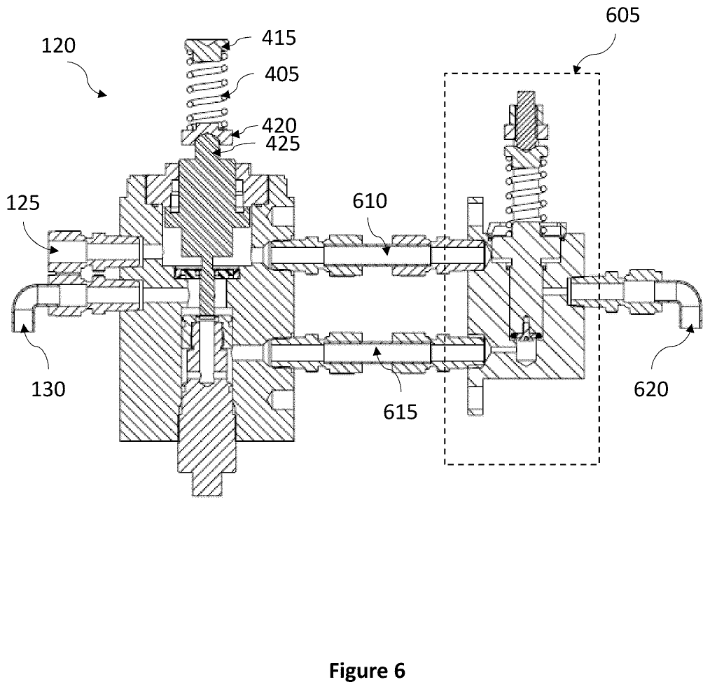

FIG. 6 shows a cross-sectional view of another embodiment of the pilot valve 120 and a modulating pilot valve assembly 605. The modulating pilot valve assembly 605 includes similar components and performs similar functionality as described in relation to the modulating pilot valve assembly 135 described in relation to FIGS. 1-5. The embodiment shown in FIG. 6 is similar to that shown in FIG. 4, except the modulating pilot valve assembly 605 can be located remotely from the pilot valve 120 and is not directly coupled to or bolted on to the pilot valve 120. For example, the modulating pilot valve assembly 605 can be coupled to the pilot valve 120 via a plurality of tubes, channels, pipes, or fluidic conduits configured to convey the inlet pressure and the dome area pressure from the pressure relief valve 105 to the modulating pilot valve assembly 605. In this way, the pilot valve 120 can be easily modified to add a modulating pilot valve assembly 605 in configurations where the footprint or available space surrounding the pilot valve 120 is limited. By fluidically coupling the modulating pilot valve assembly 605 via the fluidic conduits, the modulating pilot valve assembly 605 can be located remotely from the pilot valve 120 and the pressure relief valve 105.

In the embodiment shown in FIG. 6, the inlet pressure of the pressure relief valve 105 can be received at the pilot valve 120 via conduit 125 and can be conveyed to the modulating pilot valve assembly 605 via conduit 610. The dome area pressure of the pressure relief valve 105 can be received at the pilot valve 120 via conduit 130 and can be conveyed to the modulating pilot valve assembly 605 via conduit 615 after the pilot valve pressure set point has been reached. Conduit 620 can be configured as a vent conduit to enable the modulating pilot valve assembly 505 to vent excess pressure to the atmosphere or to a vent pipe of the pressure relief valve 105.

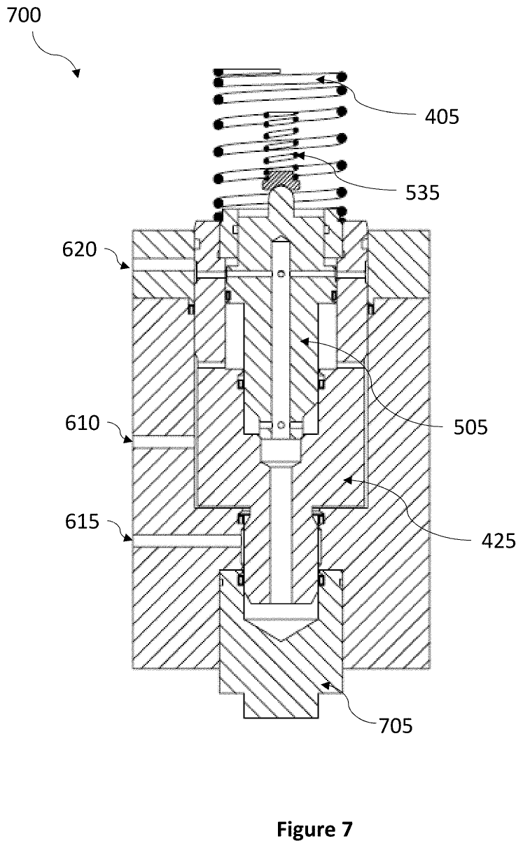

FIG. 7 is a cross-sectional view of another embodiment of a pilot valve and a modulating pilot valve assembly where components of the modulating pilot valve assembly are integrated directly within the pilot valve to form an integrated modulating pilot valve assembly 700. Integrating components of the modulating pilot valve assembly within the pilot valve can reduce the operational and/or installation space required for the pressure relief valve system and can also provide pilot valve modulation without requiring retro-fit of “pop”-type pilot valves using a modular modulating pilot valve assembly, as shown and described in relation to FIGS. 4 and 6.

Similar to coupled embodiments of the pilot valve 120 and the modulating pilot valve assembly 135 described in relation to FIGS. 1-6, the integrated modulating pilot valve assembly 700 shown and described in relation to FIG. 7 can control the opening and closing of a pressure relief valve in proportion to changes in the inlet system pressure conveyed, for example via conduit 610 of FIG. 6. As shown in FIG. 7, the integrated modulating pilot valve assembly 700 can include a spring 405 as shown an described in relation to FIG. 4. The spring 405 can enable the integrated modulating pilot valve assembly 700 to configure a preset pressure set point at which the pressure relief valve begins to open. The biasing mechanism 535 can be configured as a spring, as shown, and can enable the integrated modulating pilot valve assembly 700 to configure a preset pressure to which the dome area pressure of the pressure relief valve is initially dropped. In response to increasing inlet or system pressures of the pressure relief valve 105, conveyed via conduit 610, the biasing mechanism 535 further allows the integrated modulating pilot valve assembly 700 to continue to modulate opening the pressure relief valve 105 by reducing the dome area pressure in proportion to increases in the inlet pressure. In some embodiments, the biasing mechanism 535 can be configured without a spring. For example, in some embodiments, the biasing mechanism can be a hydraulic piston. The integrated modulating pilot valve assembly 700 also includes blowdown adjustment mechanism 705. The blowdown adjustment mechanism 705 can adjust the pilot valve blowdown. The pilot valve blowdown can be described as the difference between the pressure at which the pilot valve opens and the pressure at which the pilot valve closes.

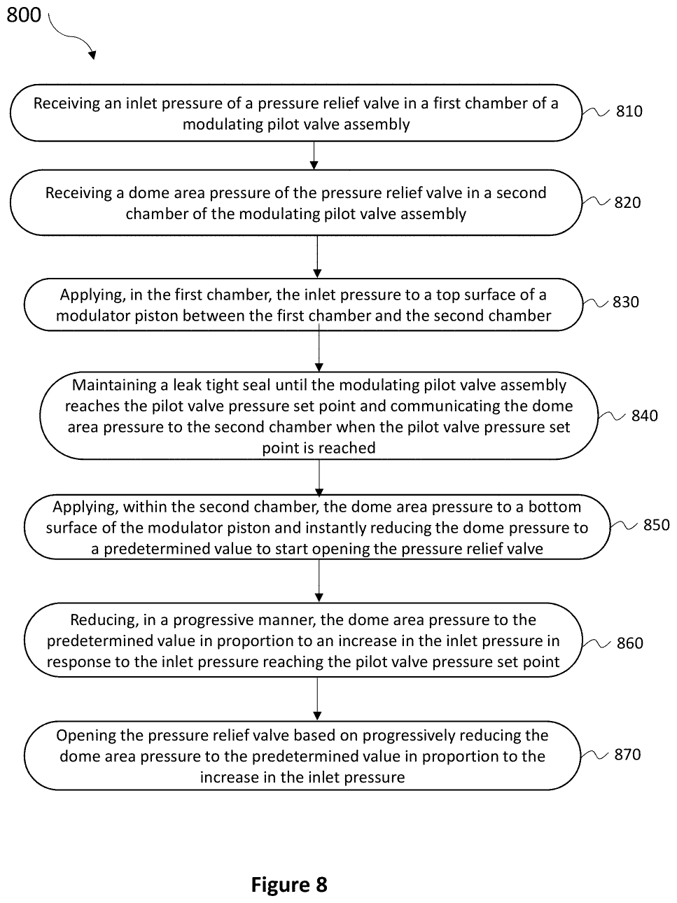

FIG. 8 is a flow chart showing an exemplary embodiment of a method 800 for modulating a pressure relief valve. While the method 800 is described in the context of modulating the pressure relief valve 105 using the modulating pilot valve assembly 135 described according to the descriptions corresponding to FIGS. 1-5, the method 800 is not limited to such configurations and can be performed to modulate other pressure relief valves using a modulating pilot valve assembly as described herein. For example, the method 800 can also be used accordingly to modulate a pressure relief valve using the modulating pilot valve assemblies described in FIGS. 6-7. The modulating pilot valve assembly 135 and the pressure relief valve 105 are configured to maintain a leak-tight seal until reaching a pilot valve pressure set point. For example, the pilot valve 120 communicates the inlet pressure associated with the inlet area 305 of the pressure relief valve 105 to the dome area 310 of the pressure relief valve 105 to keep the valve and disc 320 in a closed position until the inlet pressure received via conduit 125 reaches the pilot valve 120 pressure set point at which the pilot valve reduces the dome area pressure instantly causing the pressure relief valve 105 to initially open. Thereafter, the modulating pilot valve assembly progressively reduces the dome area pressure in proportion to an increase in the inlet pressure of the pressure relief valve 105. As a result, the pressure relief valve 105 can open in proportion to increases in the inlet pressure.

In step 810, the modulating pilot valve assembly 135 receives an inlet pressure of a pressure relief valve 105. The inlet pressure is received in a first chamber 520. The inlet pressure can be conveyed from an inlet area 305 of the pressure relief valve 105 via a first conduit, such as conduit 125 coupling the inlet area 305 to the first chamber 520 of the modulating pilot valve assembly 135. In some embodiments, the modulating pilot valve assembly 135 can include additional chambers to receive the inlet pressure. In some embodiments, the area of the first chamber 520 can vary with respect to a pre-determined modulation curve corresponding to one or more operational parameters of the modulating pilot valve assembly 135.

In step 820, the modulating pilot valve assembly 135 receives a dome area pressure of the pressure relief valve 105. The dome area pressure is received in a second chamber 525. The dome area pressure can be conveyed from the dome area 310 of the pressure relief valve 105 via a second conduit, such as conduit 130 coupling the dome area 310 to the second chamber 525 of the modulating pilot valve assembly 105. In some embodiments, the modulating pilot valve assembly 135 can include additional chambers to receive the dome area pressure. In some embodiments, the area of the second chamber 525 can vary with respect to a pre-determined modulation curve corresponding to one or more operational parameters of the modulating pilot valve assembly 135.

In step 830, the modulating pilot valve assembly 135 applies, in the first chamber 520, the inlet pressure to a top surface 510 of a modulator piston 505 between the first chamber 520 and the second chamber 525. The modulator piston 505 can separate the first chamber 520 and the second chamber 525. The inlet pressure conveyed via conduit 125 is received in the first chamber 520 and is applied to the top surface 510 of the piston 505.

In step 840, the modulating pilot valve assembly 135 maintains a leak-tight seal of itself and of the pressure relief valve 105 until the modulating pilot valve assembly 135 reaches the pilot valve pressure set point. The dome area pressure can then be communicated to the second chamber 525 when the pilot valve pressure set point is reached.

In step 850, the modulating pilot valve assembly 135 applies, within the second chamber 525, the dome area pressure to the bottom surface 515 of the modulator piston 505 and instantly reducing the dome area pressure to a predetermined value to start opening the pressure relief valve. Upon reaching the pilot valve pressure set point, the modulating pilot valve assembly 135 instantly reduces the dome area pressure and causes the pressure relief valve 105 to initially open. In response, the pressure relief valve 105 can open via a second biasing mechanism of the modulating pilot valve assembly 135.

In step 860, the modulating pilot valve assembly 135 progressively reduces the dome area pressure to the predetermined value in proportion to an increase in the inlet pressure. The predetermined value for which the dome area pressure is reduced in proportion to inlet pressure increases can be adjusted via the lock screw 530. In some embodiments, the modulating pilot valve assembly 135 can be configured to reduce the dome area pressure to zero instead of the predetermined value.

As the inlet pressure continues to increase, the modulating pilot valve assembly 135 relieves dome area pressure to the atmosphere until the force from the inlet pressure applied to the top surface 510 of the piston 505 is sufficient to move the piston to a closed position. In this closed position, a certain amount of pressure remains in the dome area 310 of the pressure relief valve 105 which is controlled by the differential surface areas of the top surface 510 and the bottom surface 515 of the piston 505 and the differential areas of the first chamber 520 and the second chamber 525 of the modulating pilot valve assembly 135. The disc 320 of the pressure relief valve 105 only partially opens at the pilot valve pressure set point since the dome area pressure has not been dropped to atmospheric pressure. The piston 505 remains in the closed position until the disc 320 is forced into an open position and higher lift by the continued increasing inlet pressure. The piston 505 can then further relieve pressure from the dome area as necessary to achieve the required opening of the disc 320 within 10% overpressure.

In this way, in step 870, the modulating pilot valve assembly 135 opens the pressure relief valve 105 based on progressively reducing the dome area pressure to the predetermined value. When the pressure relief valve 105 has opened sufficiently to reduce the inlet pressure to the pre-determined blow-down pressure of the modulating pilot valve assembly 135, the piston 505 closed the vent seal and simultaneously opens the inlet conduit in the modulating pilot valve assembly 135. The inlet pressure is again redirected to the dome area 310 of the pressure relief valve 105. As the dome area pressure equalizes with the inlet pressure, the downward force created by the differential areas of the disc 320 closes the pressure relief valve 105.

Exemplary technical effects of the systems, devices, and methods of modulating a pilot valve configured to actuate a pressure relief valve described herein include, by way of non-limiting example, improved pilot valve modulation and leak-tight pressure relief valve operation. By providing improved pilot valve modulation, the systems, devices, and methods allow a pressure relief valve to achieve a tighter operating gap between the pressure relief valve operating pressure and the pilot valve pressure set point, as well as enhanced operational efficiency. The modulating pilot valve assembly described herein improves leak-tight performance while providing continuous modulation via discharging dome area pressure in proportion to inlet pressure increases. In addition, the modulating pilot valve assembly can be coupled to existing “pop”-type pilot valves enabling operators to update non-modulating pilot valves for continuous pilot valve modulation, more efficient pressure relief valve operation and reduced leakage of the pressure relief valve within tighter operating gaps.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A modulating pilot valve assembly, comprising:
a first chamber coupled to a pilot valve on a pressure relief valve, the first chamber configured to receive an inlet pressure of an inlet of the pressure relief valve via a first conduit coupling the pilot valve to the inlet of the pressure relief valve, wherein the pilot valve includes a first biasing mechanism configured to adjust a pilot valve pressure set point;
a second chamber coupled to the pilot valve, the second chamber configured to receive a dome area pressure of a dome area of the pressure relief valve via a second conduit coupling the pilot valve to the dome area of the pressure relief valve, wherein an area of the first chamber is greater than an area of the second chamber;
a modulator piston between the first chamber and the second chamber, the modulator piston including a top surface to which the inlet pressure is applied within the first chamber and a bottom surface to which the dome area pressure is applied within the second chamber, wherein an area of the bottom surface is greater than an area of the top surface;
wherein the modulating pilot valve assembly and the pressure relief valve are configured to maintain a leak-tight seal until reaching the pilot valve pressure set point, at which the modulating pilot valve assembly instantly reduces the dome area pressure via a second biasing mechanism of the modulating pilot valve assembly, causing the pressure relief valve to initially open and thereafter to progressively reduce the dome area pressure in proportion to an increase in the inlet pressure and to cause the pressure relief valve to open in proportion to the increase in the inlet pressure.

2. The modulating pilot valve assembly of claim 1, wherein the modulating pilot valve assembly is disposed within the pilot valve.

3. The modulating pilot valve assembly of claim 1, wherein the second biasing mechanism includes a spring and a hydraulic piston configured to provide a preset biasing force to reduce the dome area pressure.

4. The modulating pilot valve assembly of claim 1, wherein the modulating pilot valve assembly is configured to control a flow of a fluid through the pressure relief valve, the fluid selected from a group consisting of a liquid, a gas, and a steam.

5. The modulating pilot valve assembly of claim 4, wherein the inlet pressure of the liquid, the steam, and the gas is between about 15 and 15000 pounds per square inch relative to atmospheric pressure.

6. The modulating pilot valve assembly of claim 1, wherein the modulating pilot valve assembly is configured to maintain the leak-tight seal of the pressure relief valve between 96% and 99% of the pilot valve pressure set point.

7. A method of modulating a pressure relief valve comprising:
receiving, in a first chamber of a modulating pilot valve assembly coupled to a pilot valve, an inlet pressure of an inlet of a pressure relief valve, the inlet pressure received via a first conduit coupling the pilot valve to the inlet of the pressure relief valve, wherein the pilot valve includes a first biasing mechanism configured to adjust a pilot valve pressure set point;
receiving, in a second chamber of the modulating pilot valve assembly coupled to the pilot valve, a dome area pressure of a dome area of the pressure relief valve, the dome area pressure received via a second conduit coupling the pilot valve to the dome area of the pressure relief valve, wherein an area of the first chamber is greater than an area of the second chamber;
applying, within the first chamber, the inlet pressure to a top surface of a modulator piston between the first chamber and the second chamber;
maintaining a leak-tight seal of the modulating pilot valve assembly and the pressure relief valve until the modulating pilot valve assembly reaches the pilot valve pressure set point and communicating the dome area pressure to the second chamber when the pilot valve pressure set point is reached;
applying, within the second chamber, the dome area pressure to a bottom surface of the modulator piston and instantly reducing the dome area pressure to a predetermined value to start opening the pressure relief valve;
reducing, by the modulating pilot valve assembly in a progressive manner, the dome area pressure to the predetermined value in proportion to an increase in the inlet pressure; and
opening the pressure relief valve based on progressively reducing the dome area pressure to the predetermined value in proportion to the increase in the inlet pressure.

8. The method of claim 7, wherein the modulating pilot valve assembly is disposed within the pilot valve.

9. The method of claim 7, wherein the second biasing mechanism is configured to adjust an opening set point of the modulator piston.

10. The method of claim 9, wherein the second biasing mechanism includes one of a spring and a hydraulic piston configured to provide a preset biasing force to instantly reduce the dome area pressure.

11. The method of claim 7, wherein the modulating pilot valve assembly is configured to control a flow of a fluid through the pressure relief valve, the fluid selected from a group consisting of a liquid, a gas, and a steam.

12. The method of claim 11, wherein the inlet pressure of the liquid, the steam, or the gas is between about 15 and 15000 pounds per square inch relative to atmospheric pressure.

13. The method of claim 7, wherein the modulating pilot valve assembly is configured to maintain the leak-tight seal of the pressure relief valve between 96% and 99% of the pilot valve pressure set point.

14. A pressure relief valve system, comprising:
a pressure relief valve configured to modulate a flow of a fluid therethrough, the pressure relief valve including an inlet area having an inlet pressure and a dome area having a dome area pressure;
a pilot valve coupled to the pressure relief valve and configured to receive the inlet pressure and the dome area pressure, the pilot valve including a first biasing mechanism configured to adjust a pilot valve pressure set point; and
a modulating pilot valve assembly coupled to the pilot valve, the modulating pilot valve assembly including
a first chamber, coupled to the pilot valve, the first chamber configured to receive the inlet pressure via a first conduit coupling the pilot valve to the inlet of the pressure relief valve,
a second chamber, coupled to the pilot valve, the second chamber configured to receive the dome area pressure via a second conduit coupling the pilot valve to the dome area of the pressure relief valve,
a modulator piston between the first chamber and the second chamber, the modulator piston including a top surface to which the inlet pressure is applied within the first chamber and a bottom surface to which the dome area pressure is applied within the second chamber, wherein an area of the bottom surface is greater than an area of the top surface,
wherein the modulating pilot valve assembly and the pressure relief valve are configured to maintain a leak-tight seal until reaching the pilot valve pressure set point, at which the modulating pilot valve assembly instantly reduces the dome area pressure via a second biasing mechanism of the modulating pilot valve assembly, causing the pressure relief valve to initially open and thereafter to progressively reduce the dome area pressure in proportion to an increase in the inlet pressure and to cause the pressure relief valve to open in proportion to the increase in the inlet pressure.

15. The system of claim 14, wherein the modulating pilot valve assembly is disposed within the pilot valve.

16. The system of claim 14, wherein the second biasing mechanism includes one of a spring and a hydraulic piston configured to provide a preset biasing force to reduce the dome area pressure.

17. The system of claim 14, wherein the modulating pilot valve assembly is configured to control the flow of the fluid through the pressure relief valve, the fluid selected from a group consisting of a liquid, a gas, or a steam.

18. The system of claim 17, wherein the inlet pressure of the liquid, the steam, or the gas is between about 15 and 15000 pounds per square inch relative to atmospheric pressure.

19. The system of claim 14, wherein the modulating pilot valve assembly is configured to maintain the leak-tight seal of the pressure relief valve between 96% and 99% of the pilot valve pressure set point.

20. The system of claim 14, wherein the first biasing mechanism is one of a spring, a washer, or a seal.
